(19) United States
(12) Patent Application Publication
(10) Pub. No.: US 2026/0095116 A1
(43) Pub. Date: Apr. 2, 2026

(54) INVERTER APPARATUS

(71) Applicant: KABUSHIKI KAISHA TOSHIBA, Tokyo (JP)

(72) Inventors: Yuki KUMAKIRI, Tokyo (JP); Tomoaki SHIGETA, Tokyo (JP)

(73) Assignee: KABUSHIKI KAISHA TOSHIBA, Tokyo (JP)

(21) Appl. No.: 19/074,588

(22) Filed: Mar. 10, 2025

(30) Foreign Application Priority Data
Sep. 30, 2024 (JP) 2024-170183

(51) Int. Cl. H02P 21/14; H02P 21/22

(52) U.S. Cl. CPC H02P 21/14; H02P 21/22

(57) ABSTRACT

An apparatus according to an embodiment includes a unit performing control so that a current applied to a permanent magnet and a synchronous machine having magnetic saliency match a command value, respectively; a unit generating a zero torque current command value so that magnet torque and reluctance torque of the synchronous machine are balanced; a unit that generates the command value in which the zero torque current command value is corrected so that an AC component is generated in at least a q-axis current; a unit acquiring a value of an estimation voltage generated by the AC component of the q-axis current; and a unit calculating a magnetic flux interlinked from the permanent magnet to a stator coil of the synchronous machine.

### CROSS-REFERENCE TO RELATED APPLICATIONS

This application is based upon and claims the benefit of priority from Japanese Patent Application No. 2024-170183, filed Sep. 30, 2024; the entire contents of which are incorporated herein by reference.

### FIELD

Embodiments described herein relate generally to an inverter apparatus.

### BACKGROUND

When the synchronous machine is driven using the inverter, a motor parameter is required. In the related art, in addition to a method of acquiring data such as motor winding resistance and inductance by a preliminary test and acquiring a motor parameter of a synchronous machine, an automatic acquisition (automatic tuning) method has been proposed. According to the automatic tuning, by calculating the estimated value of the motor parameter during the stop, it is possible to quickly construct the control system after connecting the permanent magnet synchronous machine and the inverter and to shorten the time until the synchronous machine operation is started.

For example, there have been proposed a method of observing a maximum value of a current flowing when a pulse voltage is applied to a synchronous machine and calculating an estimated value of a magnet magnetic flux by using a correlation between the maximum value and a magnitude of a magnet magnetic flux, a method of estimating a magnet magnetic flux by using a correlation between a high-frequency impedance calculated by a high-frequency current generated when a high-frequency voltage is applied to the synchronous machine and a magnet magnetic flux, and a method of estimating a magnet magnetic flux by using a correlation between a strain amount of teeth acquired by a strain gauge and a magnet magnetic flux.

However, in a case where a method that requires a test using a dedicated environment is used in order to acquire characteristics of a target synchronous machine in advance, cost increases, and the method cannot be applied in a case where the target synchronous machine is not known. In addition, in a case where a method that requires addition of a sensor is used, the material cost increases.

### BRIEF DESCRIPTION OF DRAWINGS

FIG. 1 is a diagram schematically illustrating a configuration example of an inverter apparatus according to a first embodiment.

FIG. 2 is a block diagram schematically illustrating a configuration example of a zero torque current command value generation unit illustrated in FIG. 1.

FIG. 3 is a block diagram schematically illustrating a configuration example of an estimation signal generation unit illustrated in FIG. 1.

FIG. 4 is a block diagram schematically illustrating a configuration example of an estimation voltage acquisition unit illustrated in FIG. 1.

FIG. 5 is a diagram schematically illustrating a configuration example of a magnet magnetic flux arithmetic unit illustrated in FIG. 1.

FIG. 6 is a flowchart for describing an example of the operation of the inverter apparatus of the first embodiment.

FIG. 7 is a timing chart for describing an example of the operation of the inverter apparatus of the first embodiment.

FIG. 8 is a diagram illustrating an example of output torque characteristics in a case where a current phase of a current supplied to the permanent magnet synchronous machine is varied under a condition where a current amplitude is constant.

FIG. 9 is a diagram for describing an example of an operation in which the zero torque current command value generation unit searches for a current phase in a case where the output torque of the synchronous machine is zero.

FIG. 10 is a diagram schematically illustrating a relationship between a dq-axis coordinate system and a d0q0-axis coordinate system obtained by rotating the dq-axis coordinate system by an output torque zero phase.

FIG. 11 is a block diagram schematically illustrating another configuration example of the zero torque current command value generation unit illustrated in FIG. 1.

FIG. 12 is a timing chart for describing an example of the operation of the inverter apparatus according to the modification of the first embodiment.

FIG. 13 is a block diagram schematically illustrating a configuration example of a zero torque current command value generation unit of the inverter apparatus according to a second embodiment.

FIG. 14 is a diagram for describing a principle of minimum amplitude search control.

FIG. 15 is a timing chart for describing an example of the operation of the inverter apparatus of the second embodiment.

FIG. 16 is a diagram schematically illustrating a configuration example of an inverter apparatus according to a third embodiment.

FIG. 17 is a block diagram schematically illustrating a configuration example of the estimation signal generation unit illustrated in FIG. 16.

FIG. 18 is a diagram schematically illustrating a configuration example of an inverter apparatus according to a fourth embodiment.

### DETAILED DESCRIPTION

An inverter apparatus according to an embodiment includes a current control unit that performs control so that a d-axis current and a q-axis current applied to a permanent magnet and a synchronous machine having magnetic saliency match a d-axis current command value and a q-axis current command value, respectively; a zero torque current command value generation unit that generates a zero torque d-axis current command value and a zero torque q-axis current command value so that magnet torque and reluctance torque of the synchronous machine are balanced; an estimation signal generation unit that generates the d-axis current command value and the q-axis current command value in which the zero torque d-axis current command value and the zero torque q-axis current command value are corrected so that an AC component is generated in at least the q-axis current; an estimation voltage acquisition unit that acquires a value of an estimation voltage generated by the AC component of the q-axis current; and a magnet magnetic flux arithmetic unit that calculates a magnet magnetic flux that is a magnetic flux interlinked from the permanent magnet to a stator coil of the synchronous machine using a value of the estimation voltage.

Hereinafter, an inverter apparatus according to an embodiment will be described with reference to the drawings.

In the inverter apparatus according to the present embodiment, the estimation voltage generated by energizing the estimation current is acquired in a state where the current is controlled so that the magnet torque and the reluctance torque of the synchronous machine are balanced, and the magnet magnetic flux as the motor parameter is calculated to perform parameter tuning.

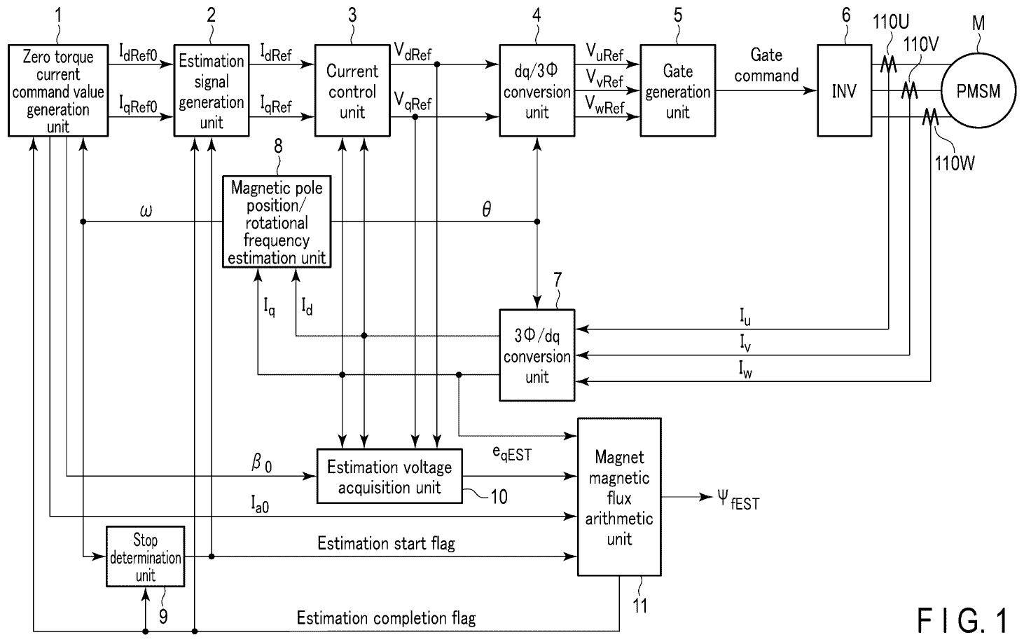

FIG. 1 is a diagram schematically illustrating a configuration example of an inverter apparatus according to the first embodiment.

The inverter apparatus of the present embodiment includes an inverter main circuit (INV) 6 and an inverter control apparatus, and controls a synchronous machine M.

The synchronous machine M is, for example, a motor having magnetic saliency such as a permanent magnet synchronous motor (PMSM). In the present embodiment, an example in which a PMSM is used as the synchronous machine M will be described.

The inverter main circuit 6 converts DC power into three-phase AC power to output the three-phase AC power to the synchronous machine M. The inverter main circuit 6 includes an upper-arm switching element and a lower-arm switching element in each phase. A control signal (gate command) of the switching elements of the upper arm and the lower arm is supplied from the inverter control apparatus to the inverter main circuit 6. Note that the inverter main circuit 6 can mutually convert AC power and DC power by switching on/off of the switching element. In accordance with an input gate command, the inverter main circuit 6 converts DC power into AC power of any voltage and frequency, supplies the AC power to the synchronous machine M, and drives the synchronous machine M.

The current detection units 110U, 110V, and 110W detect three-phase AC currents (Iᵤ, Iᵥ, I_{w}) flowing from the inverter main circuit 6 to the synchronous machine M. At least two-phase current values of the three-phase AC current flowing to the synchronous machine M may be detected, and in a case where two-phase current values are detected, the current value of the remaining one phase can be calculated using the detected two-phase current values.

The inverter control apparatus includes a zero torque current command value generation unit 1, an estimation signal generation unit 2, a current control unit 3, a dq/3Φ conversion unit 4, a gate generation unit 5, a 3Φ/dq conversion unit 7, a magnetic pole position/rotational frequency estimation unit 8, a stop determination unit 9, an estimation voltage acquisition unit 10, and a magnet magnetic flux arithmetic unit 11.

The inverter control apparatus may include, for example, an arithmetic apparatus including a processor and a memory storing a program executed by the processor, and can realize various functions described below by software or a combination of software and hardware.

The gate generation unit 5 converts the three-phase voltage command values V_{uRef}, V_{vRef}, and V_{wRef} into gate commands. In the present embodiment, the gate generation unit 5 generates a gate command by, for example, PWM modulation for comparing the triangular wave carrier with the voltage command values V_{uRef}, V_{vRef}, and V_{wRef}, to output the gate command to the inverter main circuit INV.

Using an estimated magnetic pole position θ, the dq/3Φ conversion unit 4 converts the voltage command values V_{dRef} and V_{qRef} supplied from the current control unit 3 into vector values V_{uRef}, V_{vRef}, and V_{wRef} of the three-phase fixed coordinate system to output the vector values V_{uRef}, V_{vRef}, and V_{wRef} to a modulation unit 104. That is, the dq/3Φ conversion unit 4 converts the voltage command value in the dq rotation coordinate system synchronized with the rotational speed of the rotor of the synchronous machine M into the voltage command value in the fixed coordinate system corresponding to the three-phase AC waveform of the synchronous machine M.

Using the estimated magnetic pole position θ, the 3Φ/dq conversion unit 7 converts the detection values Iᵤ, Iᵥ, and I_{w} of the current detection units 110U, 110V, and 110W from the values in the three-phase fixed coordinate system into the values of the d-axis current I_{d} and the q-axis current I_{q} in the estimation rotation coordinate system. That is, the 3Φ/dq conversion unit 7 converts the current value in the fixed coordinate system corresponding to the three-phase AC waveform of the synchronous machine M into the current value in the dq rotation coordinate system synchronized with the rotational speed of the rotor of the synchronous machine M.

Note that the d-axis is a vector axis rotated by the estimated magnetic pole position θ from the α-axis (U phase) of the αβ fixed coordinate system, and the q-axis is a vector axis orthogonal to the d-axis at an electrical angle. On the other hand, the estimation rotation coordinate system corresponds to the d-axis and the q-axis at the estimated position of the rotor of the synchronous machine M. That is, in the estimation rotation coordinate system, the d-axis is a vector axis rotated from the α-axis by the estimated magnetic pole position θ, and the q-axis is a vector axis orthogonal to the d-axis (estimation rotation coordinate system) in an electrical angle.

For example, the current control unit 3 performs control so that the d-axis current and the q-axis current supplied to the synchronous machine M having the permanent magnet and the magnetic saliency match the d-axis current command value and the q-axis current command value, respectively. The current control unit 3 performs, for example, PI control, generates a d-axis voltage command V_{dRef} by calculating a sum of a component obtained by multiplying a deviation between the d-axis current I_{d} and the d-axis current command value I_{dRef} generated by dq coordinate axis conversion of the three-phase AC currents Iᵤ, Iᵥ, and I_{w} by a gain and a component obtained by multiplying an integral value of the deviation by a gain, and generates a q-axis voltage command value V_{qRef} by calculating a sum of a component obtained by multiplying a deviation between the q-axis current I_{q} and the q-axis current command value I_{qRef} by a gain and a component obtained by multiplying an integral value of the deviation by a gain. The d-axis voltage command value V_{dRef} and the q-axis voltage command value V_{qRef} generated by the current control unit 3 are supplied to the dq/3Φ conversion unit 4.

The magnetic pole position/rotational frequency estimation unit 8 calculates and outputs an estimated value of the magnetic pole position Oreal and the rotational frequency (angular velocity) ω by a known method using the values of the d-axis current I_{d} and the q-axis current I_{q} output from the 3Φ/dq conversion unit 7. The magnetic pole position/rotational frequency estimation unit 8 can acquire information such as motor parameters such as motor winding resistance and inductance, a voltage command value, and a high-frequency voltage superimposed on the voltage command value as necessary, and calculate a rotational frequency (angular velocity) ω. The magnetic pole position/rotational frequency estimation unit 8 can calculate the estimated magnetic pole position θ by integrating the calculated values of the rotational frequency (angular velocity).

Since the rotor of the synchronous machine M is stopped when the parameter tuning is being performed, the magnetic pole position/rotational frequency estimation unit 8 may be configured to output the angular velocity ω as 0 (zero).

The magnetic pole position/rotational frequency estimation unit 8 supplies the calculated angular velocity ω to the zero torque current command value generation unit 1 and the stop determination unit 9, and supplies the calculated estimated magnetic pole position θ to the dq/3Φ conversion unit 4 and the 3Φ/dq conversion unit 7.

The stop determination unit 9 sets the estimation start flag to 0 in a case where the angular velocity ω is not 0 rad/s, and sets the estimation start flag to 1 in a case where the angular velocity ω is 0 rad/s. The stop determination unit 9 supplies the value of the generated estimation start flag to the estimation signal generation unit 2 and the magnet magnetic flux arithmetic unit 11. Note that the stop determination unit 9 operates during the period in which the output torque zero control is performed, and the value of the estimation start flag can be set to 0 (initial value) at the start time point and the end time point of the output torque zero control. In addition, the stop determination unit 9 may acquire a value of an estimation completion flag to be described later, determine that the estimation is completed at a timing when the estimation completion flag changes from 0 to 1, set the estimation start flag to 0 (initial value), and end the stop determination.

The zero torque current command value generation unit 1 performs output torque zero control, and generates a zero torque d-axis current command value I_{dRef0} and a zero torque q-axis current command value I_{qRef0}. Here, the output torque zero control is control for generating a current command value (a zero torque d-axis current command value and a zero torque q-axis current command value) so that the magnet torque and the reluctance torque of the synchronous machine M are balanced, and setting the output torque of the synchronous machine M to 0 (zero).

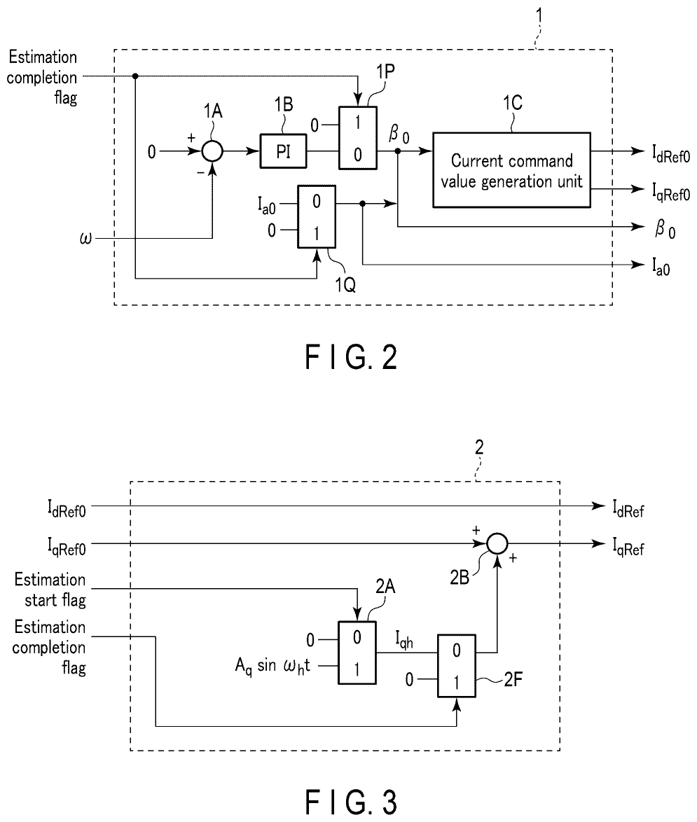

FIG. 2 is a block diagram schematically illustrating a configuration example of a zero torque current command value generation unit illustrated in FIG. 1.

The zero torque current command value generation unit 1 includes a subtraction unit 1A, a PI control unit 1B, a current command value generation unit 1C, and output switching units 1P and 1Q.

The subtraction unit 1A calculates and outputs a difference (−ω) obtained by subtracting the angular velocity ω from 0 (angular velocity command value 0 rad/s).

The PI control unit 1B calculates and outputs the current phase β₀ of the zero current command value so that the output value (−ω) of the subtraction unit 1A follows zero. The output value of the PI control unit 1B is input to the output switching unit 1P.

The output switching unit 1P switches the output value according to a value of an estimation completion flag to be described later. The output switching unit 1P outputs the output value (current phase β₀) of the PI control unit 1B in a case where the value of the estimation completion flag is 0, and outputs 0 in a case where the value of the estimation completion flag is 1. The output switching unit 10 switches the output value according to a value of an estimation completion flag to be described later. The output switching unit 10 outputs the current amplitude command value Iₐ₀ in a case where the value of the estimation completion flag is 0, and outputs 0 in a case where the value of the estimation completion flag is 1.

The current command value generation unit 1C calculates the zero torque d-axis current command value I_{dRef0} and the zero torque q-axis current command value I_{qRef0} based on the following Expressions (1) and (2) using the output value (current phase β₀) of the PI control unit 1B and the current amplitude command value Iₐ₀. The current amplitude command value Iₐ₀ can be set to, for example, a rated current value of the synchronous machine M to be controlled. That is, in the present embodiment, the magnitude of the vector sum of the zero torque d-axis current command value I_{dRef0} and the zero torque q-axis current command value I_{qRef0} is set to the rated current value of the synchronous machine M.

$${I}_{dRef 0} = \text{?} cos {β}_{0} \qquad ( 1 )$$

$${I}_{qRef 0} = \text{?} sin {β}_{0} \qquad ( 2 )$$

$$\text{?} \text{indicates text missing or illegible when filed}$$

The zero torque current command value generation unit 1 supplies the calculated zero torque d-axis current command value I_{dRef0} and zero torque q-axis current command value I_{qRef0} to the estimation signal generation unit 2.

The zero torque current command value generation unit 1 may be configured to acquire a value of an estimation completion flag to be described later, and stop the calculation of the zero torque d-axis current command value I_{dRef0} and the zero torque q-axis current command value I_{qRef0} at the timing when the estimation completion flag changes from 0 to 1.

The estimation signal generation unit 2 acquires the value of the estimation start flag, the zero torque d-axis current command value I_{dRef0}, and the zero torque q-axis current command value I_{qRef0} to generate the d-axis current command value I_{dRef} and the q-axis current command value I_{qRef} in which the zero torque d-axis current command value I_{dRef0} and the zero torque q-axis current command value I_{qRef0} are corrected so that an AC component is generated at least in the q-axis current I_{q}.

In the present embodiment, the estimation signal generation unit 2 starts energization of the estimation current in a case where the output torque zero control is in a stop state (ω=0) after starting the output torque zero control, and adds the q-axis estimation signal Ich as an AC component to the zero torque q-axis current command value I_{qRef0} to generate the q-axis current command value I_{qRef}.

FIG. 3 is a block diagram schematically illustrating a configuration example of an estimation signal generation unit illustrated in FIG. 1. The estimation signal generation unit 2 includes output switching units 2A and 2F and an addition unit 2B.

The output switching unit 2A switches the value of the q-axis estimation signal I_{qh} according to the value of the estimation start flag. The output switching unit 2A outputs the q-axis estimation signal I_{qh} as 0 in a case where the estimation start flag is 0 (rotation state), and outputs the q-axis estimation signal I_{qh} as A_{q} sin ωₕt by the following Expression (3) in a case where the estimation start flag is 1 (stop state).

$${I}_{qh} = {A}_{q} sin {ω}_{h} t \qquad ( 3 )$$

In the above Expression (3), A_{q} is set so that the torque ripple caused by the energization of the q-axis estimation signal is less than a predetermined value. In the present embodiment, for example, the A_{q} is set so that the torque ripple is less than 5% of the rated torque of the synchronous machine M.

In the above Expression (3), On is set to a value sufficiently slower than the cutoff frequency of the current control unit 3. In the present embodiment, for example, ωₕ is set to be 1/10 of the cutoff frequency of the current control unit 3.

The output switching unit 2F switches the output value according to a value of an estimation completion flag to be described later. The output switching unit 2F outputs the output value (q-axis estimation signal I_{qh}) of the output switching unit 2A in a case where the value of the estimation completion flag is 0, and outputs 0 in a case where the value of the estimation completion flag is 1.

The addition unit 2B outputs a q-axis current command value I_{qRef} which is a sum obtained by adding the output value (q-axis estimation signal I_{qh} in a case where the value of the estimation completion flag is 0) of the output switching unit 2A to the zero torque q-axis current command value I_{qRef0}.

The estimation signal generation unit 2 supplies the d-axis current command value I_{dRef} and the q-axis current command value I_{qRef} to the current control unit 3. The estimation signal generation unit 2 outputs the zero torque d-axis current command value I_{dRef0} acquired from the zero torque current command value generation unit 1 to the current control unit 3 as the d-axis current command value I_{dRef}.

Note that the estimation signal generation unit 2 may be configured to acquire a value of an estimation completion flag to be described later, stop output of the d-axis current command value I_{dRef} and the q-axis current command value I_{qRef} for estimation at timing when the estimation completion flag changes from 0 to 1, and end energization of the estimation current.

The estimation voltage acquisition unit 10 acquires the value of the estimation voltage e_{qEST} generated by the AC component of the q-axis current I_{q} from the values of the d-axis current I_{d} and the q-axis current I_{q}, the d-axis voltage command value V_{dRef} and the q-axis current command value V_{qRef}, and the value of the current phase β₀ during the output torque zero control.

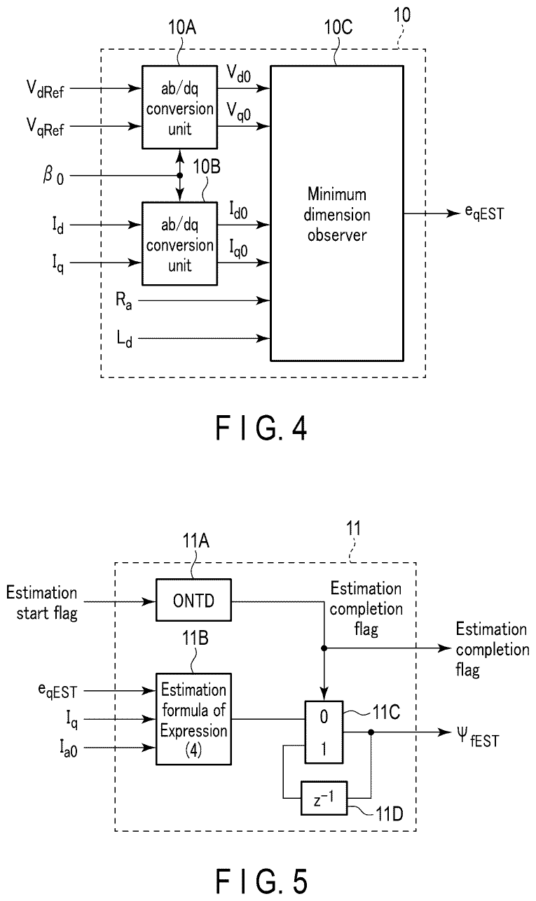

FIG. 4 is a block diagram schematically illustrating a configuration example of an estimation voltage acquisition unit illustrated in FIG. 1. The estimation voltage acquisition unit 10 includes ab/dq conversion units 10A and 10B and a minimum dimension observer 10C.

The ab/dq conversion unit 10A acquires a d-axis voltage command value V_{dRef}, a q-axis current command value V_{qRef}, and a current phase β₀, coordinate-converts each of the d-axis voltage command value V_{dRef} and the q-axis current command value V_{qRef} with the current phase β₀, and calculates and outputs a d-axis voltage command value V_{d0} and a q-axis voltage command value V_{q0} for output torque zero control.

The ab/dq conversion unit 10B acquires a value of the d-axis current I_{d}, a value of the q-axis current I_{q}, and a current phase β₀, coordinate-converts each of the d-axis current I_{d} and the q-axis current I_{q} with the current phase β₀, and calculates and outputs a d-axis current command value I_{d0} and a q-axis current command value I_{q0} for output torque zero control.

Using the d-axis voltage command value V_{d0}, the q-axis voltage command value V_{q0}, the d-axis current command value I_{d0}, and the q-axis current command value I_{q0} for output torque zero control, the minimum dimension observer 10C calculates and outputs an estimation voltage e_{qEST} generated by allowing an AC component (q-axis estimation signal I_{qh}) of the q-axis current to flow through the synchronous machine M. That is, the minimum dimension observer 10C can have a model equation that simulates the operation from the inverter control circuit to the inverter main circuit INV and the synchronous machine M, and can calculate the voltage generated when the synchronous machine M is driven by the input voltage command value and current command value.

The magnet magnetic flux arithmetic unit 11 calculates a magnet magnetic flux estimated value ψ_{fEST}, which is a magnetic flux interlinked from the permanent magnet of the synchronous machine M to the stator coil, from the estimation voltage e_{qEST}, the q-axis current I_{q}, and the current amplitude command value Iₐ₀ according to the value of the estimation start flag.

FIG. 5 is a diagram schematically illustrating a configuration example of a magnet magnetic flux arithmetic unit illustrated in FIG. 1.

The magnet magnetic flux arithmetic unit 11 includes a delay circuit 11A, an estimated value calculation unit 11B, an output switching unit 11C, and a unit time delay unit 11D.

The delay circuit 11A acquires the value of the estimation start flag, to output an estimation completion flag obtained by delaying the timing at which the estimation start flag rises by a predetermined time. That is, the calculation of the magnet magnetic flux estimated value ψ_{fEST} is completed by the lapse of a predetermined time after the generation of the estimation signal is started (after the estimation start flag changes from 0 to 1), and the estimation completion flag changes from 0 to 1 after the calculation of the magnet magnetic flux estimated value ψ_{fEST} is completed. In the present embodiment, as the predetermined time for delaying the input value in the delay circuit 11A, for example, a time for 10 cycles of the AC component (q-axis estimation signal I_{qh}) of the estimation current is set. The initial value of the estimation completion flag at the start of the output torque zero control can be set to 0.

The estimated value calculation unit 11B calculates the magnet magnetic flux estimated value ψ_{fEST} from the estimation voltage e_{qEST}, the q-axis current I_{q}, and the current amplitude command value Iₐ₀ using the estimation formula of the following Expression (4).

$${Ψ}_{fEST} = \frac{{e}_{qEST} {I}_{a 0}}{{sI}_{q}} \qquad ( 4 )$$

s is a differential operator.

The unit time delay unit 11D inputs a value (previous value) obtained by delaying the output value of the output switching unit 11C by a unit time to the output switching unit 11C.

The output switching unit 11C acquires the output value of the estimated value calculation unit 11B and the output value of the unit time delay unit 11D to output any of the input values. In a case where the output value (estimation completion flag) of the delay circuit 11A is 0, the output switching unit 11C updates the output value with the magnet magnetic flux estimated value ψ_{fEST} supplied from the estimated value calculation unit 11B. In a case where the estimation completion flag is 1, the output switching unit 11C holds and outputs the previous value (the output value of the unit time delay unit 11D) as the magnet magnetic flux estimated value ψ_{fEST}.

In the present embodiment, the estimation completion flag changes from 0 to 1 after a predetermined time elapses from the timing when the estimation start flag changes from 0 to 1, the energization of the estimation current by the estimation signal generation unit 2 is stopped, and the magnet magnetic flux arithmetic unit 11 holds the magnet magnetic flux estimated value ψ_{fEST} as the output value. The magnet magnetic flux arithmetic unit 11 supplies the value of the estimation completion flag to the zero torque current command value generation unit 1, the estimation signal generation unit 2, and the stop determination unit 9.

The stop determination unit 9, the estimation voltage acquisition unit 10, and the magnet magnetic flux arithmetic unit 11 may be set to stop the operation until the output torque zero control is started next when the magnet magnetic flux estimated value ψ_{fEST}, which is a motor parameter, is updated and the parameter tuning is completed.

Next, an example of the operation of the above-described inverter apparatus will be described.

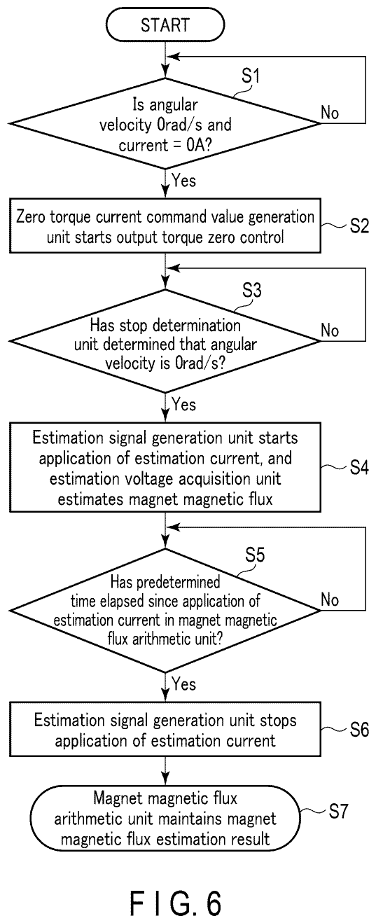

FIG. 6 is a flowchart for describing an example of the operation of the inverter apparatus of the first embodiment.

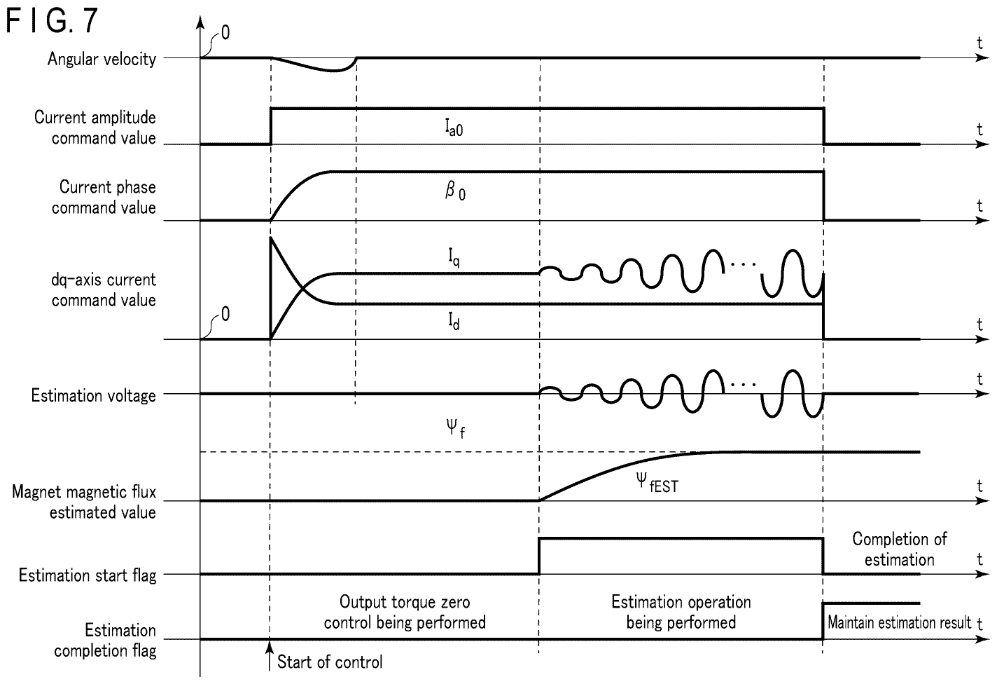

FIG. 7 is a timing chart for describing an example of the operation of the inverter apparatus of the first embodiment.

When parameter tuning is started, first, the zero torque current command value generation unit 1 acquires the angular velocity ω and the current command values I_{d} and I_{q}, and determines whether the angular velocity ω is 0 rad/s and the current command values I_{d} and I_{q} are 0 A (step S1).

In response to the angular velocity ω being 0 rad/s and the current command values I_{d} and I_{q} being 0 A (step S1, Yes), the zero torque current command value generation unit 1 starts generation of the zero torque d-axis current command value I_{dRef0} and the zero torque q-axis current command value I_{qRef0}, and starts output torque zero control (step S2).

Subsequently, the stop determination unit 9 determines whether the angular velocity ω is 0 rad/s (step S3). The stop determination unit 9 outputs the estimation start flag as 1 in a case where the angular velocity ω is 0 rad/s (step S3, Yes), and outputs the estimation start flag as 0 in a case where the angular velocity ω is not 0 rad/s (step S3, No).

In a case where the estimation start flag changes from 0 to 1, the estimation signal generation unit 2 starts energization of the estimation current, and the magnet magnetic flux arithmetic unit 11 calculates the magnet magnetic flux estimated value ψ_{fEST} using the estimation voltage calculated by the estimation voltage acquisition unit 10 (step S4).

When a predetermined time elapses from the timing at which the value of the estimation start flag changes from 0 to 1 (step S5, Yes), the magnet magnetic flux arithmetic unit 11 sets the estimation completion flag from 0 to 1.

In a case where the estimation completion flag changes from 0 to 1, energization of the estimation current is stopped by the estimation signal generation unit 2 (step S6), and the magnet magnetic flux estimated value ψ_{fEST} calculated by the magnet magnetic flux arithmetic unit 11 is held (step S7).

Next, the principle of calculating the magnet magnetic flux estimated value by the output torque zero control performed in the inverter apparatus of the present embodiment will be described.

The output torque of the permanent magnet synchronous machine is given as the total torque which is the sum of the magnet torque of the first term and the reluctance torque of the second term as in the following Expression (5).

$$T = p \{ {Ψ}_{f} {I}_{a} sin β + ( {L}_{d} - {L}_{q} ) {{I}_{a}}^{2} sin βcosβ \} \qquad ( 5 )$$

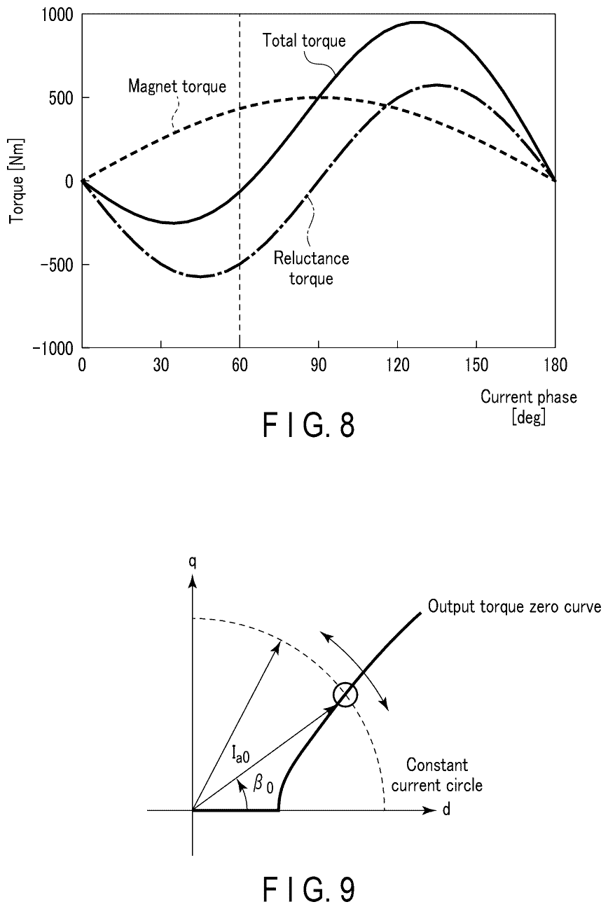

FIG. 8 is a diagram illustrating an example of output torque characteristics in a case where a current phase of a current supplied to the permanent magnet synchronous machine is varied under a condition where a current amplitude is constant.

Referring to FIG. 8, it can be seen that there is an operating point (a state in which the magnet torque and the reluctance torque are balanced) at which both the values of the magnet torque and the reluctance torque are canceled and the total torque is 0 Nm by controlling the permanent magnet synchronous machine with the current phase in which the magnet torque of the synchronous machine M is positive and the reluctance torque is negative. The condition of the current phase β (Thereafter, the output torque zero phase) in a case where the total torque is 0 Nm is expressed by Expression (6).

$$cos β = \frac{{Ψ}_{f}}{- ( {L}_{d} - {L}_{q} ) \text{?}} \qquad ( 6 )$$

$$\text{?} \text{indicates text missing or illegible when filed}$$

The zero torque current command value generation unit 1 searches for the output torque zero phase by operating the current phase so that the angular velocity matches the angular velocity command value 0 rad/s in a state where the current amplitude command value Iₐ₀ is given.

FIG. 9 is a diagram for describing an example of an operation in which the zero torque current command value generation unit searches for a current phase in a case where the output torque of the synchronous machine is zero.

In a case where the current phase β changes in the above Expression (6), the degree of magnetic saturation between the d-axis inductance Ld and the q-axis inductance Lq also changes. Therefore, the right side of Expression (6) does not have a constant value, and a curve (hereinafter, referred to as an output torque zero curve) as illustrated in FIG. 9 is drawn. That is, searching for the output torque zero phase under a condition where the current amplitude is constant results in changing the operating point on the constant current circle and searching for the intersection of the output torque zero curve and the constant current circle.

The voltage equation of the permanent magnet synchronous machine is expressed by the following Expression (7), and is expressed by the following Expression (8) in a case where the permanent magnet synchronous machine is stopped.

$$[ \begin{matrix}{v}_{d} \\ {v}_{q}\end{matrix} ] = [ \begin{matrix}\text{?} + {sL}_{d} & - ω {L}_{q} \\ ω {L}_{d} & \text{?} + {sL}_{q}\end{matrix} ] [ \begin{matrix}{i}_{d} \\ {i}_{q}\end{matrix} ] + [ \begin{matrix}0 \\ {ωΨ}_{f}\end{matrix} ] \qquad ( 7 )$$

$$[ \begin{matrix}{v}_{d} \\ {v}_{q}\end{matrix} ] = [ \begin{matrix}\text{?} + {sL}_{d} & 0 \\ 0 & \text{?} + {sL}_{q}\end{matrix} ] [ \begin{matrix}{i}_{d} \\ {i}_{q}\end{matrix} ] \qquad ( 8 )$$

$$\text{?} \text{indicates text missing or illegible when filed}$$

In a case where the above Expression (8) is modified and subjected to coordinate conversion at the output torque zero phase, the following Expression (9) is obtained.

$$[ \begin{matrix}{v}_{d 0} \\ {v}_{q 0}\end{matrix} ] = [ \begin{matrix}\text{?} + {sL}_{d} & 0 \\ 0 & \text{?} + {sL}_{d}\end{matrix} ] [ \begin{matrix}{i}_{d 0} \\ {i}_{q 0}\end{matrix} ] + [ \begin{matrix}- ( {L}_{d} - {L}_{q} ) {si}_{q} sin {β}_{0} \\ - ( {L}_{d} - {L}_{q} ) {si}_{q} cos {β}_{0}\end{matrix} ] \qquad ( 9 )$$

$$\text{?} \text{indicates text missing or illegible when filed}$$

In Expression (9), the axes before the coordinate transformation are denoted as the d-axis and the q-axis and the axes after the coordinate transformation are denoted as the do-axis and the q0-axis.

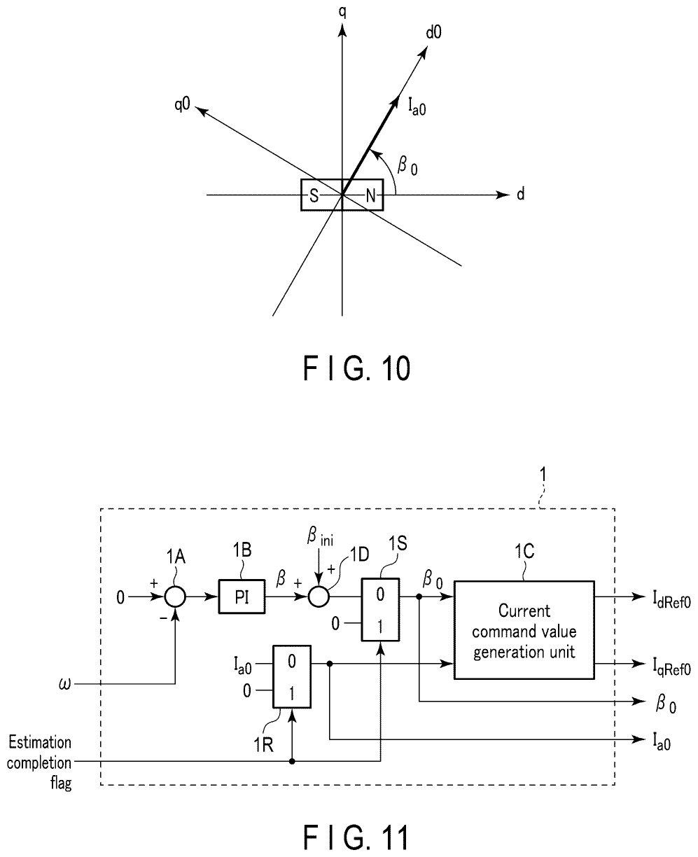

FIG. 10 is a diagram schematically illustrating a relationship between a dq-axis coordinate system and a d0q0-axis coordinate system obtained by rotating the dq-axis coordinate system by an output torque zero phase.

The relationship between the dq-axis coordinate system and the d0q0-axis coordinate system is as illustrated in FIG. 10, and the current amplitude Iₐ₀ and the do-axis coincide with each other.

In a case where the third term of the q0-axis component V_{q0} of Expression (9) is extracted as the estimation voltage e_{qEST}, the following Expression (10) is obtained, and during the output torque zero control, Expression (6) is satisfied, so that Expression (4), which is the estimation formula, can be derived by combining the two Expressions.

$${e}_{qEST} = - ( {L}_{d} - {L}_{q} ) {si}_{q} cos {β}_{0} \qquad ( 10 )$$

$${Ψ}_{fEST} = \frac{{e}_{qEST} {I}_{a 0}}{{sI}_{q}} \qquad ( 4 )$$

As described above, according to the inverter apparatus of the present embodiment, by energizing the synchronous machine M with the AC component as the estimation current while controlling the current phase in which the magnet torque and the reluctance torque are balanced, the estimation voltage e_{qEST}, which is a state quantity correlated with the magnet magnetic flux even when the synchronous machine M is in the stopped state, can be observed, and the magnet magnetic flux estimated value ψ_{fEST} can be calculated using the estimation voltage e_{qEST}.

That is, in the inverter apparatus of the present embodiment, in order to acquire the value of the magnet magnetic flux which is the motor parameter, it is not necessary to perform a test using a dedicated environment for acquiring the characteristics of the target synchronous machine in advance, and it is not necessary to newly add a sensor. Therefore, it is possible to avoid an increase in cost. As described above, according to the present embodiment, it is possible to provide an inverter apparatus capable of suppressing an increase in cost and acquiring a motor parameter.

Next, a modification of the inverter apparatus of the first embodiment will be described with reference to the drawings.

In the following description, the same components as those of the inverter apparatus of the first embodiment are denoted by the same reference numerals, and detailed description thereof is omitted.

In the inverter apparatus of the first embodiment described above, an example is described in which the zero torque current command value generation unit 1 searches for the output torque zero phase β₀ by operating the current phase so that the angular velocity command value 0 rad/s matches the angular velocity ω in a state where the current amplitude command value Iₐ₀ is given. In the modification of the first embodiment, an example in which an initial value is given to a current phase operated by the zero torque current command value generation unit 1 will be described.

FIG. 11 is a block diagram schematically illustrating another configuration example of the zero torque current command value generation unit illustrated in FIG. 1.

In the present embodiment, the zero torque current command value generation unit 1 includes a subtraction unit 1A, a PI control unit 1B, an addition unit 1D, a current command value generation unit 1C, and output switching units 1R and 1S.

The subtraction unit 1A calculates and outputs a difference (−ω) obtained by subtracting the angular velocity ω from 0 (angular velocity command value 0 rad/s).

The PI control unit 1B calculates and outputs the current phase β of the zero current command value so that the output value (−ω) of the subtraction unit 1A follows zero.

The addition unit 1D calculates a sum obtained by adding the output value β of the PI control unit 1B and the initial value βᵢₙᵢ of the current phase to output the sum as the current phase β₀ during the output torque zero control.

The output switching unit 1S switches the output value according to the value of the estimation completion flag. The output switching unit 1S outputs the output value (current phase β₀) of the addition unit 1D in a case where the value of the estimation completion flag is 0, and outputs 0 in a case where the value of the estimation completion flag is 1. The output switching unit 1R switches the output value according to a value of an estimation completion flag to be described later. The output switching unit 1R outputs the current amplitude command value Iₐ₀ in a case where the value of the estimation completion flag is 0, and outputs 0 in a case where the value of the estimation completion flag is 1.

In a case where the estimation completion flag is 0, the current command value generation unit 1C acquires the output value β₀ of the addition unit 1D and the current amplitude command value Iₐ₀. The current command value generation unit 1C calculates the zero torque d-axis current command value I_{dRef0} and the zero torque q-axis current command value I_{qRef0} based on the above Expressions (1) and (2) using the output value β₀ of the addition unit 1D and the current amplitude command value Iₐ₀. The current amplitude command value Iₐ₀ can be set to, for example, a rated current value of the synchronous machine M to be controlled.

The zero torque current command value generation unit 1 supplies the calculated zero torque d-axis current command value I_{dRef0} and zero torque q-axis current command value I_{qRef0} to the estimation signal generation unit 2.

The present modification is similar to the inverter apparatus of the first embodiment except for the configuration of the zero torque current command value generation unit 1.

In the present modification, the zero torque d-axis current command value I_{dRef0} and the zero torque q-axis current command value I_{qRef0} are calculated by adding the initial value βᵢₙᵢ of the current phase to the result of operating the current phase so that the angular velocity matches the angular velocity command value 0 rad/s in a state where the current amplitude command value Iₐ₀ is given. The initial value βᵢₙᵢ of the current phase is set to, for example, the previous value of the current phase β₀ during the output torque zero control.

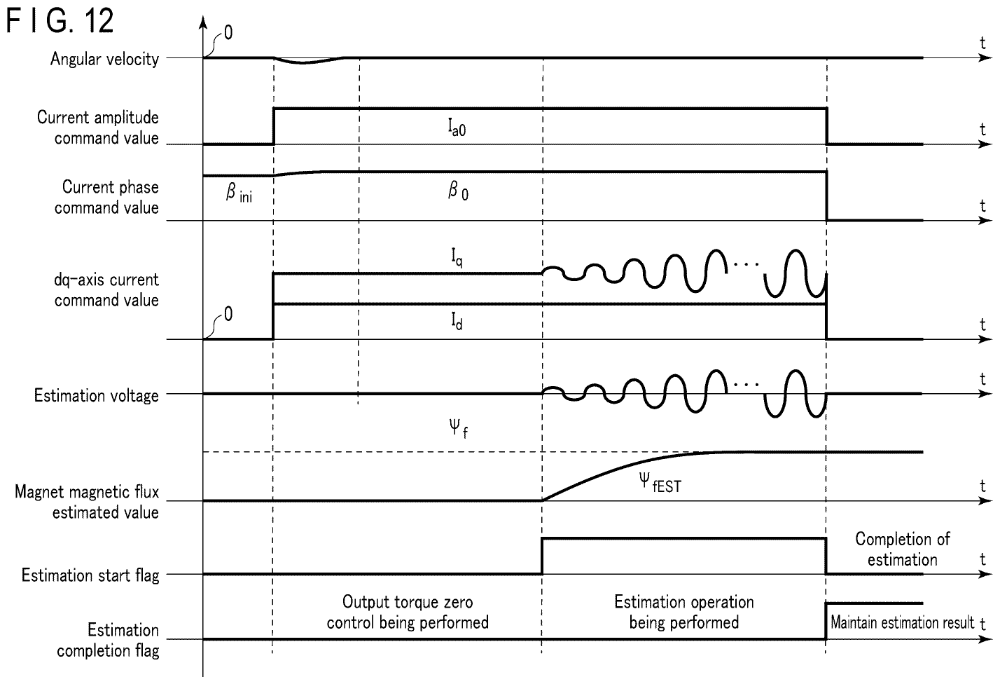

FIG. 12 is a timing chart for describing an example of the operation of the inverter apparatus according to the modification of the first embodiment.

As illustrated in FIG. 12, by setting an appropriate initial value βᵢₙᵢ at the time of searching for the current phase β₀ during the output torque zero control, the time until the synchronous machine M stops can be shortened, and the vibration of the angular velocity ω generated until the output torque converges to the zero phase can be suppressed.

As described above, according to the present modification, it is possible to provide an inverter apparatus capable of suppressing an increase in cost and acquiring a motor parameter as in the first embodiment described above. Further, according to the present modification, it is possible to shorten the time required for parameter tuning and to suppress the rotation of the synchronous machine M at the time of parameter tuning.

Next, an inverter apparatus according to the second embodiment will be described in detail with reference to the drawings.

The inverter apparatus of the present embodiment is different from the first embodiment described above in that the zero torque current command value generation unit 1 searches for the minimum current amplitude (thereafter, minimum amplitude search control) at which the magnet torque and the reluctance torque of the synchronous machine M are balanced.

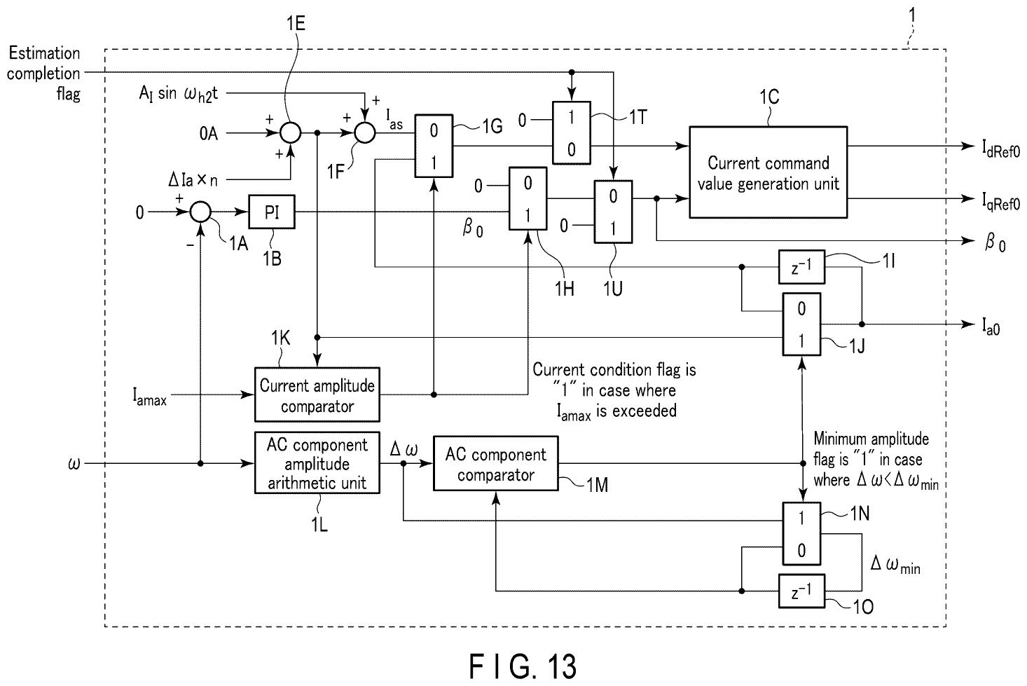

FIG. 13 is a block diagram schematically illustrating a configuration example of a zero torque current command value generation unit of the inverter apparatus according to the second embodiment.

In the present embodiment, the zero torque current command value generation unit 1 includes a subtraction unit 1A, a PI control unit 1B, a current command value generation unit 1C, addition units 1E and 1F, output switching units 1G, 1H, 1J, 1N, 1T, and 1U, unit time delay units 1I and 1O, a current amplitude comparator 1K, an AC component amplitude arithmetic unit 1L, and an AC component comparator 1M.

The subtraction unit 1A calculates and outputs a difference (−ω) obtained by subtracting the angular velocity ω from 0 (angular velocity command value 0 rad/s).

The PI control unit 1B calculates and outputs the current phase β₀ of the zero current command value so that the output value (−ω) of the subtraction unit 1A follows zero.

The addition unit 1E calculates and outputs a sum obtained by adding 0 A, which is an initial value of the current amplitude, and an increment ΔIa×n (n is the frequency of the AC signal) for each cycle of the AC signal. For example, ΔIa is set to 10% of the rated current value of the synchronous machine M. The output value of the addition unit 1E is a current amplitude value whose magnitude is adjusted for each cycle of the AC component of the current amplitude, and is supplied to the addition unit 1F, the output switching unit 1J, and the current amplitude comparator 1K.

The addition unit 1F calculates and outputs a sum Iₐₛ obtained by adding the AC signal Iₐₕ of the following Expression (11) to the current amplitude value (ΔIa×n) output from the addition unit 1E. The output value Iₐₛ of the addition unit 1F is supplied to the output switching unit 1G.

$${I}_{dqh} = {A}_{dq} sin {ω}_{h} t \qquad ( 11 )$$

In Expression (11), the amplitude A_{I} is set so that the torque ripple caused by energizing the synchronous machine M with the AC signal to less than a predetermined value. The amplitude A_{I} is set, for example, so that the torque ripple is less than 5% of the rated torque of the synchronous machine M.

The phase ωₕ₂ is set to a value sufficiently slower than the cutoff frequency of the current control unit. The phase ωₕ₂ is set to 1/10 of the cutoff frequency of the current control unit 3, for example.

The current amplitude comparator 1K compares the current amplitude (ΔIa×n) output from the addition unit 1E with the current condition threshold value Iₐₘₐₓ, and sets the current condition flag to 0 in a case where the current amplitude (ΔIa×n) is equal to or smaller than the current condition threshold value Iₐₘₐₓ, and sets the current condition flag to 1 in a case where the current amplitude (ΔIa×n) exceeds (exceeds) the current condition threshold value Iₐₘₐₓ. The current condition threshold value Iₐₘₐₓ is set to, for example, the rated current of the synchronous machine M to be controlled. The current amplitude comparator 1K supplies the current condition flag to the output switching units 1G and 1H.

The zero torque current command value generation unit 1 of the present embodiment performs the minimum amplitude search control in a case where the current condition flag is 0, and performs the output torque zero control in a case where the current condition flag is 1.

The output switching unit 1G acquires the output value Iₐₛ of the addition unit 1F and the previous value of the current amplitude Iₐ₀ output from the unit time delay unit 1I, and switches the output value according to the value of the current condition flag. The output switching unit 1G outputs the previous value of the current amplitude command value Iₐ₀ in a case where the current condition flag is 1, and outputs the output value Iₐₛ of the addition unit 1F as the current amplitude command value Iₐ₀ in a case where the current condition flag is 0.

The output switching unit 1T switches the output value according to the value of the estimation completion flag. The output switching unit 1T outputs the output switching unit 1G output value in a case where the value of the estimation completion flag is 0, and outputs 0 in a case where the value of the estimation completion flag is 1.

The output switching unit 1H acquires 0 and the output value of the PI control unit 1B, and switches the output value according to the value of the current condition flag. The output switching unit 1H outputs the output value of the PI control unit 1B as the phase β₀ in a case where the current condition flag is 1, and outputs 0 as the phase β₀ in a case where the current condition flag is 0.

The output switching unit 1U switches the output value according to the value of the estimation completion flag. The output switching unit 1U outputs the output value of the output switching unit 1H in a case where the value of the estimation completion flag is 0, and outputs 0 in a case where the value of the estimation completion flag is 1.

In a case where the value of the estimation completion flag is 0, the current command value generation unit 1C calculates the zero torque d-axis current command value I_{dRef0} and the zero torque q-axis current command value I_{qRef0} based on the above Expressions (1) and (2) using the current phase β₀ and the current amplitude command value Iₐ₀.

The AC component amplitude arithmetic unit 1L extracts the same component as the AC signal Iₐₕ added to the current amplitude from the angular velocity ω, and calculates the amplitude Δω of the extracted AC component. The AC component amplitude arithmetic unit 1L supplies the calculated amplitude Δω to the AC component comparator 1M.

The AC component comparator 1M compares the amplitude Δω with the minimum value Δωₘᵢₙ of the amplitude component, and in a case where the amplitude Δω falls below the minimum value Δωₘᵢₙ (Δω<Δωₘᵢₙ), the minimum amplitude flag is set to 1, and in a case where the amplitude Δω is greater than or equal to the minimum value Δωₘᵢₙ (Δω≥Δωₘᵢₙ), the minimum amplitude flag is set to 0. The AC component comparator supplies the value of the minimum amplitude flag to the output switching units 1J and 1N.

The output switching unit 1J acquires the output value of the addition unit 1E and the previous value of the current amplitude command value Iₐ₀ output from the unit time delay unit 1I, and switches the output value (current amplitude command value) Iₐ₀ according to the value of the minimum amplitude flag. In a case where the minimum amplitude flag is 0 (Δω≥Δωₘᵢₙ), the output switching unit 1J outputs the previous value without updating the value of the current amplitude command value Iₐ₀. In a case where the minimum amplitude flag is 1 (Δω<Δωₘᵢₙ), the output switching unit 1J outputs the output value (current value) of the addition unit 1E as the current amplitude Iₐ₀.

The output switching unit 1N acquires the angular velocity ω and the previous value of the minimum value Δωₘᵢₙ output from the unit time delay unit 10, and switches the output value Δωₘᵢₙ according to the value of the minimum amplitude flag. In a case where the minimum amplitude flag is 0, the output switching unit 1N outputs the previous value without updating the value of the minimum value Δωₘᵢₙ. In a case where the minimum amplitude flag is 1, the output switching unit 1N outputs the amplitude Δω (current value) as a minimum value Δωₘᵢₙ.

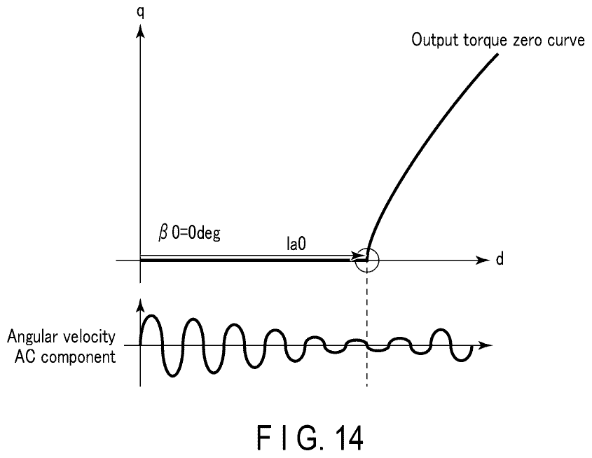

FIG. 14 is a diagram for describing a principle of minimum amplitude search control.

In a case where the current amplitude command value Iₐ₀ is increased under the condition of the current phase=0 deg, the current amplitude reaches the intersection of the output torque zero curve and the d-axis. At this time, as the current amplitude command value Iₐ₀ increases, the AC component of the angular velocity ω caused by the AC component (AC signal Iₐₕ) added to the current amplitude attenuates, and the AC component of the angular velocity ω has a minimum value at the timing when the current amplitude reaches the intersection of the d-axis and the output torque zero curve. This is because the operating point changes along the vicinity of the output torque zero curve, so that the torque pulsation is hardly generated, and as a result, the AC component of the angular velocity ω is smaller than other operating points.

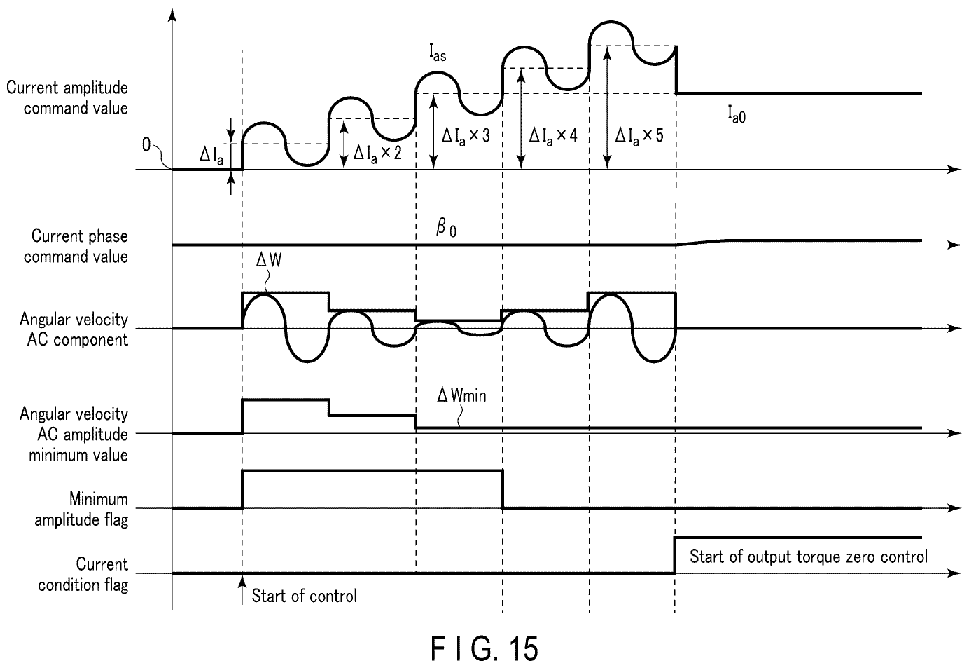

FIG. 15 is a timing chart for describing an example of the operation of the inverter apparatus of the second embodiment.

As can be seen from FIG. 15, as the current amplitude command value Iₐ₀ increases, the amplitude of the AC component of the angular velocity ω decreases, but as the current amplitude command value Iₐ₀ further increases, the amplitude of the AC component of the angular velocity ω tends to increase.

That is, in the inverter apparatus of the present embodiment, the current amplitude command value Iₐ₀ in a case where the AC component of the angular velocity ω is minimum is searched for by the minimum amplitude search control, and the search result is held by the output switching unit 1J as the current amplitude command value Iₐ₀ of the output torque zero control, whereby the output torque zero control can be performed with the minimum current amplitude.

Therefore, according to the inverter apparatus of the present embodiment, the same effects as those of the above-described first embodiment can be obtained, the magnet torque and the reluctance torque of the synchronous machine M can be balanced at the minimum current amplitude, and the loss generated by energizing the synchronous machine M with the current at the time of parameter tuning can be minimized.

Next, an inverter apparatus according to the third embodiment will be described in detail with reference to the drawings.

In the inverter apparatus of the first embodiment described above, the estimation current is applied only to the q-axis of the synchronous machine M. However, the inverter apparatus of the present embodiment is different from the first embodiment in that the estimation current is applied not only to the q-axis of the synchronous machine M but also to the d-axis.

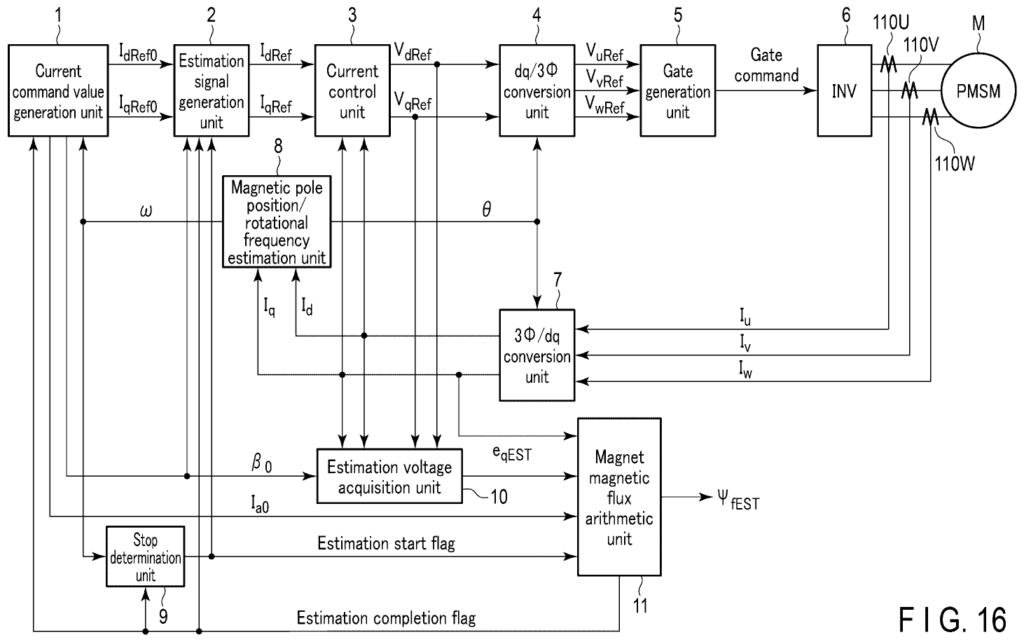

FIG. 16 is a diagram schematically illustrating a configuration example of an inverter apparatus according to a third embodiment.

The present embodiment is different from the first embodiment in that the current phase β₀ is input from the zero torque current command value generation unit 1 to the estimation signal generation unit 2.

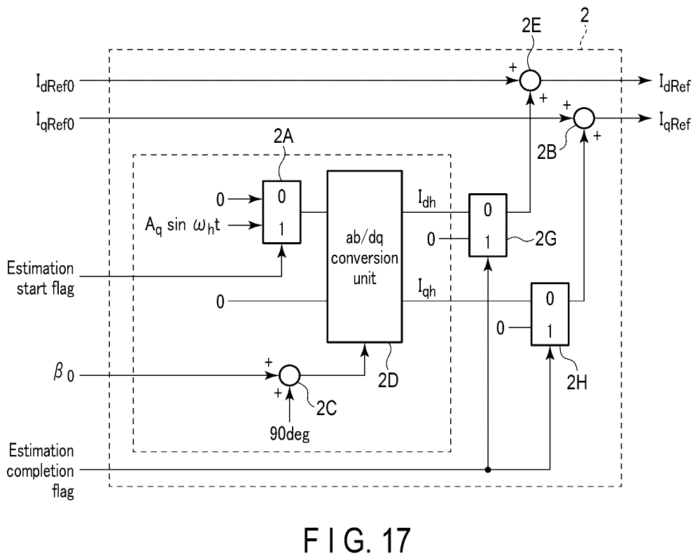

FIG. 17 is a block diagram schematically illustrating a configuration example of the estimation signal generation unit illustrated in FIG. 16.

In the inverter apparatus of the present embodiment, the estimation signal generation unit 2 includes output switching units 2A, 2G, and 2H, addition units 2B, 2C, and 2E, and an ab/dq conversion unit 2D.

The output switching unit 2A acquires 0 A and the dq-axis estimation signal I_{dqh}, and switches the output value according to the value of the estimation start flag. The output switching unit 2A outputs 0 A in a case where the estimation start flag is 0, and outputs the dq-axis estimation signal I_{dqh} of the following Expression (12) in a case where the estimation start flag is 1.

$${I}_{dqh} = {A}_{dq} sin {ω}_{h} t \qquad ( 12 )$$

The amplitude A_{dq} of the dq-axis estimation signal I_{dqh} is set so that, for example, the torque ripple generated by energizing the synchronous machine M is less than 5% of the rated torque of the synchronous machine M.

The addition unit 2C outputs a phase obtained by adding the current phases β₀ and 90 deg during the output torque zero control to the ab/dq conversion unit 2D.

The ab/dq conversion unit 2D acquires 0 and the output value of the output switching unit 2A, performs rotational coordinate conversion of the value acquired with the phase supplied from the addition unit 2C to generate a d-axis estimation signal I_{dh} and a q-axis estimation signal I_{qh}.

The output switching unit 2G acquires 0 and the d-axis estimation signal I_{dh}, and switches the output value according to the value of the estimation completion flag. The output switching unit 2G outputs the d-axis estimation signal I_{dh} in a case where the estimation completion flag is 0, and outputs 0 in a case where the estimation start flag is 1.

The output switching unit 2H acquires 0 and the q-axis estimation signal I_{qh}, and switches the output value according to the value of the estimation completion flag. The output switching unit 2H outputs the q-axis estimation signal I_{qh} in a case where the estimation completion flag is 0, and outputs 0 in a case where the estimation start flag is 1.

The addition unit 2B outputs a sum obtained by adding the q-axis estimation signal I_{qh} calculated by the ab/dq conversion unit 2D and the zero torque q-axis current command value I_{qRef0} as a q-axis current command value I_{qRef}.

The addition unit 2E outputs a sum obtained by adding the d-axis estimation signal I_{dh} calculated by the ab/dq conversion unit 2D and the zero torque d-axis current command value I_{dRef0} as a d-axis current command value I_{dRef}.

According to the present embodiment described above, the same effects as those of the first embodiment described above can be obtained, and torque pulsation (ripple) caused by energization of the estimation current can be reduced by applying the estimation current not only to the q-axis but also to the d-axis of the synchronous machine M.

Next, an inverter apparatus according to the fourth embodiment will be described in detail with reference to the drawings.

The inverter apparatus of the present embodiment further includes an AC voltage detection unit (voltage sensor) 12 and a 3Φ/dq conversion unit 13, and is different from the above-described first embodiment in that a d-axis voltage V_{d} and a q-axis voltage V_{q} generated from detection values (three-phase voltage) of a voltage sensor 12 are used as voltages to be input to the estimation voltage acquisition unit 10 instead of the d-axis voltage command value V_{dRef} and the q-axis voltage command value V_{qRef}.

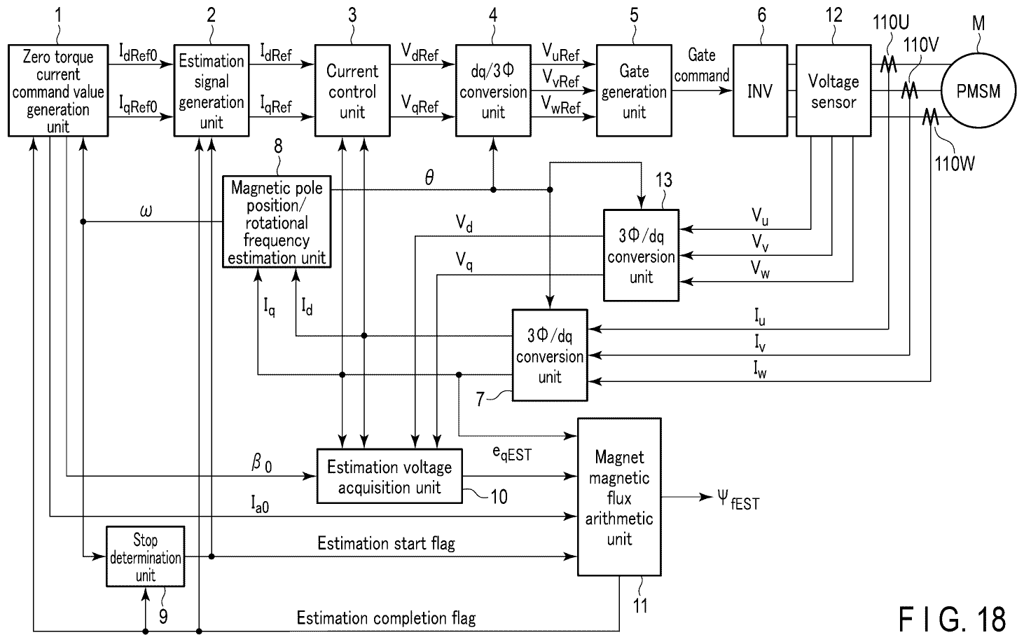

FIG. 18 is a diagram schematically illustrating a configuration example of an inverter apparatus according to the fourth embodiment.

The voltage sensor 12 detects the three-phase AC voltage supplied from the inverter main circuit 6 to the synchronous machine M, and supplies the detection values Vu, Vv, and Vw to the 3Φ/dq conversion unit 13.

The 3Φ/dq conversion unit 13 converts the detection values Vu, Vv, and Vw supplied from the voltage sensor 12 into the d-axis voltage V_{d} and the q-axis voltage V_{q} of the dq rotation coordinate system using the estimated magnetic pole position θ acquired from the magnetic pole position/rotational frequency estimation unit 8. The 3Φ/dq conversion unit 13 supplies the d-axis voltage Va and the q-axis voltage V_{q} to the estimation voltage acquisition unit 10.

The configuration of the inverter apparatus of the present embodiment other than the above is similar to that of the first embodiment described above. According to the present embodiment, it is possible to obtain the same effects as those of the first embodiment described above, eliminate the influence of the error occurring between the voltage command value and the output voltage, and improve the estimation accuracy of the motor parameter.

The program according to the present embodiment may be transferred in a state of being stored in the electronic device, or may be transferred in a state of not being stored in the electronic device. In the latter case, the program may be transferred via a network or may be transferred in a state of being stored in a storage medium. The storage medium is a non-transitory tangible medium. The storage medium is a computer-readable medium. The storage medium may be any medium that can store a program such as a CD-ROM or a memory card and can be read by a computer, and its form is not limited.

Although some embodiments of the present invention have been described, these embodiments have been presented as examples, and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An inverter apparatus comprising:
a current control unit that performs control so that a d-axis current and a q-axis current applied to a permanent magnet and a synchronous machine having magnetic saliency match a d-axis current command value and a q-axis current command value, respectively;
a zero torque current command value generation unit that generates a zero torque d-axis current command value and a zero torque q-axis current command value so that magnet torque and reluctance torque of the synchronous machine are balanced;
an estimation signal generation unit that generates the d-axis current command value and the q-axis current command value in which the zero torque d-axis current command value and the zero torque q-axis current command value are corrected so that an AC component is generated in at least the q-axis current;
an estimation voltage acquisition unit that acquires a value of an estimation voltage generated by the AC component of the q-axis current; and
a magnet magnetic flux arithmetic unit that calculates a magnet magnetic flux that is a magnetic flux interlinked from the permanent magnet to a stator coil of the synchronous machine using a value of the estimation voltage.

2. The inverter apparatus according to claim 1, wherein the zero torque current command value generation unit generates the zero torque d-axis current command value and the zero torque q-axis current command value so that an angular velocity command value of 0 rad/s matches an angular velocity of the synchronous machine.

3. The inverter apparatus according to claim 1, wherein the zero torque current command value generation unit generates a current command value in which an AC component is superimposed on a current amplitude, adjusts a magnitude of the current amplitude for each cycle of an AC component of the current amplitude, searches for a current amplitude command value that minimizes an amplitude of an AC component of an angular velocity of the synchronous machine, and generates the zero torque d-axis current command value and the zero torque q-axis current command value using the current amplitude command value.

4. The inverter apparatus according to claim 1, wherein the estimation signal generation unit generates the d-axis current command value and the q-axis current command value in which the zero torque d-axis current command value and the zero torque q-axis current command value are corrected so that an AC component is generated in a phase orthogonal to a current phase in which magnet torque and reluctance torque of the synchronous machine are balanced.

5. The inverter apparatus according to claim 1, wherein a magnitude of a vector sum of the zero torque d-axis current command value and the zero torque q-axis current command value is set as a rated current value of the synchronous machine.

6. The inverter apparatus according to claim 2, wherein a magnitude of a vector sum of the zero torque d-axis current command value and the zero torque q-axis current command value is set as a rated current value of the synchronous machine.

7. The inverter apparatus according to claim 3, wherein a magnitude of a vector sum of the zero torque d-axis current command value and the zero torque q-axis current command value is set as a rated current value of the synchronous machine.

8. The inverter apparatus according to claim 4, wherein a magnitude of a vector sum of the zero torque d-axis current command value and the zero torque q-axis current command value is set as a rated current value of the synchronous machine.
